(19) United States
(12) Patent Application Publication
(10) Pub. No.: US 2021/0039655 A1
(43) Pub. Date: Feb. 11, 2021

(54) PROPOSING METHOD AND PROPOSING SYSTEM

(71) Applicant: Toyota Jidosha Kabushiki Kaisha, Toyota-shi Aichi-ken (JP)

(72) Inventors: Naohiko Saito, Nagoya-shi (JP); Takashi Doi, Toyota-shi (JP); Naoyuki Sakamoto, Nisshin-shi (JP)

(73) Assignee: Toyota Jidosha Kabushiki Kaisha, Toyota-shi Aichi-ken (JP)

(21) Appl. No.: 16/893,889

(22) Filed: Jun. 5, 2020

(30) Foreign Application Priority Data
Aug. 9, 2019 (JP) 2019-147934

(51) Int. Cl. B60W 40/09; B60W 50/08; G07C 5/08; G07C 5/00

(52) U.S. Cl. CPC B60W 40/09; B60W 50/08; B60W 2556/10; G07C 5/008; B60W 2540/30; G07C 5/0808

(57) ABSTRACT

A proposing method of proposing the tuning of a vehicle includes a step of acquiring information about the vehicle by using an acquisition device installed in the vehicle when the vehicle is driven by a driver and a step of determining the driving characteristics of the driver based on the information about the vehicle and proposing the tuning of the vehicle appropriate for the driver.

### CROSS-REFERENCE TO RELATED APPLICATIONS

This application claims priority to Japanese Patent Application No. 2019-147934 filed on Aug. 9, 2019, which is incorporated herein by reference in its entirety including the specification, drawings and abstract.

### BACKGROUND

### 1. Technical Field

The disclosure relates to a proposing method and a proposing system.

### 2. Description of Related Art

In the related art, there is a known vehicle driving characteristic diagnosing system that is provided with a drive recorder (acquisition device) installed in a vehicle and an information center making a driving diagnosis based on information collected by the drive recorder (for example, refer to Japanese Unexamined Patent Application Publication No. 2002-319087 (JP 2002-319087 A).

In the vehicle driving characteristic diagnosing system, the result of analysis about each diagnostic item such as fuel efficiency is displayed on a display such that a driver is notified of the result of a diagnosis. In addition, the vehicle driving characteristic diagnosing system is configured such that a driver can compare his or her own driving characteristics with the driving characteristics of others and advice for improving a driving operation is displayed.

### SUMMARY

Here, in the case of the above-described vehicle driving characteristic diagnosing system in the related art, advice for improving the driving operation is given by the information collected by the drive recorder and it is desirable to effectively use the information collected by the drive recorder.

The disclosure provides a proposing method and a proposing system with which it is possible to effectively use information collected by an acquisition device.

A first aspect of the disclosure relates to a proposing method of proposing the tuning of a vehicle. The proposing method includes a step of acquiring information about the vehicle by using an acquisition device installed in the vehicle when the vehicle is driven by a driver and a step of determining the driving characteristics of the driver based on the information about the vehicle and proposing the tuning of the vehicle appropriate for the driver.

With such a configuration, it is possible to promote tuning matching the driving characteristics of each driver and thus it is possible to promote vehicle performance improvement appropriate for each driver. Accordingly, it is possible to propose the tuning of the vehicle appropriate for the driver by using the information about the vehicle collected by the acquisition device and thus it is possible to effectively use the information about the vehicle collected by the acquisition device.

The proposing method according to the first aspect may further include a step of causing the driver to have a simulated experience of driving the vehicle after the tuning by using a driving simulator.

With such a configuration, the driver can have a simulated experience of how the vehicle is changed through the proposed tuning. Therefore, it is possible to easily determine whether or not to apply the proposed tuning.

A second aspect of the disclosure relates to a proposing system for proposing tuning of a vehicle. The proposing system includes an acquisition device and an information processing apparatus. The acquisition device is configured to acquire information about the vehicle when the vehicle is driven by a driver, the acquisition device being installable in the vehicle. The information processing apparatus is for determining the driving characteristics of the driver based on the information about the vehicle and proposing the tuning of the vehicle appropriate for the driver.

In this case, it is possible to promote tuning matching the driving characteristics of each driver and thus it is possible to promote vehicle performance improvement appropriate for each driver. Accordingly, it is possible to propose the tuning of the vehicle appropriate for the driver by using the information about the vehicle collected by the acquisition device and thus it is possible to effectively use the information about the vehicle collected by the acquisition device.

The proposing system according to the second aspect may further include a driving simulator for causing the driver to have a simulated experience of driving the vehicle after the tuning.

With such a configuration, the driver can have a simulated experience of how the vehicle is changed through the proposed tuning. Therefore, it is possible to easily determine whether or not to apply the proposed tuning.

With the proposing method and the proposing system according to the aspects of the disclosure, it is possible to effectively use information collected by an acquisition device.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing a schematic configuration of a proposing system according to an embodiment;

FIG. 2 is a block diagram for describing a vehicle-mounted device of the proposing system in FIG. 1;

FIG. 3 is a flowchart for describing a proposing method in which the proposing system according to the embodiment is used; and

FIG. 4 is a block diagram showing a schematic configuration of a proposing system according to a modification example of the embodiment.

### DETAILED DESCRIPTION OF EMBODIMENTS

Hereinafter, an embodiment of the disclosure will be described.

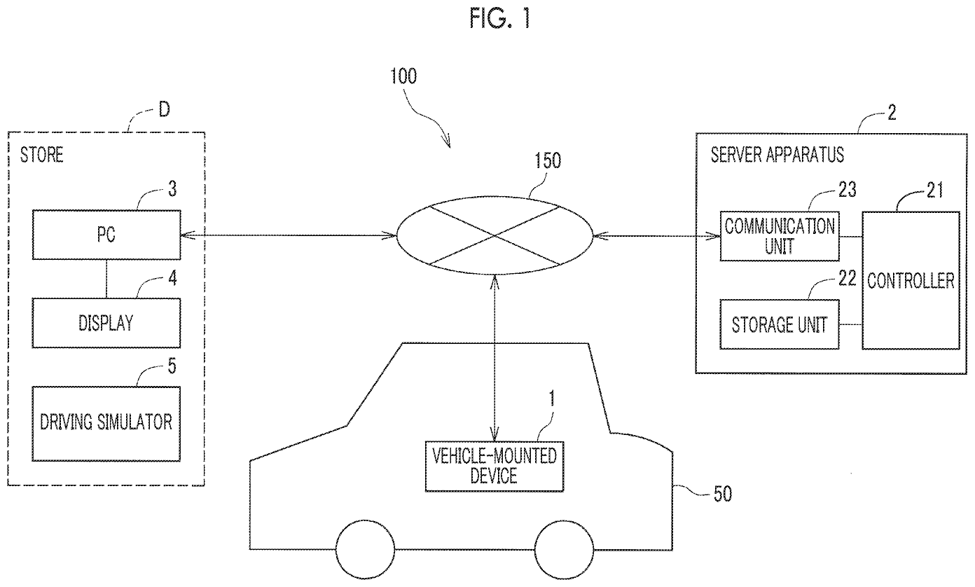

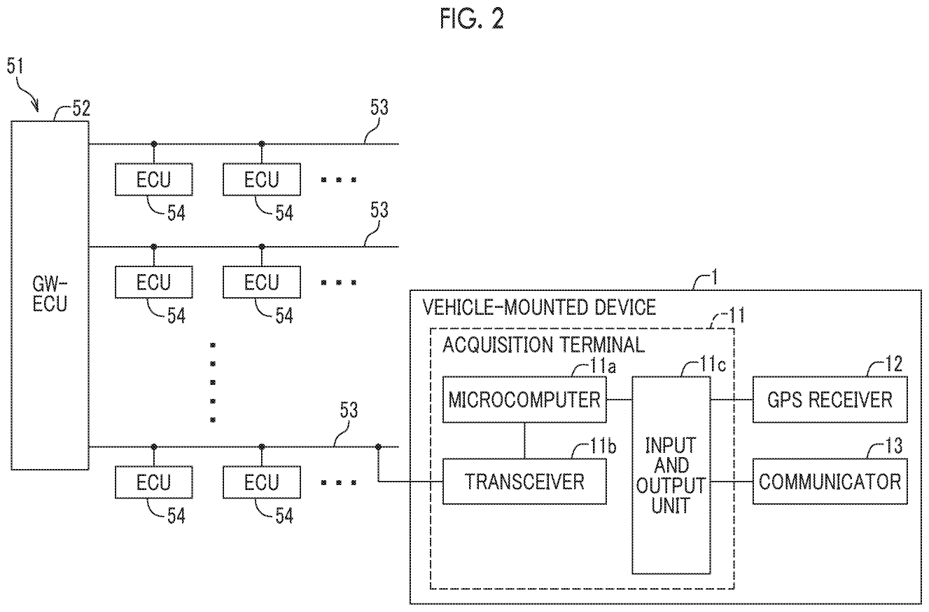

First, the configuration of a proposing system 100 according to the embodiment of the disclosure will be described with reference to FIGS. 1 and 2.

The proposing system 100 is used when a salesperson at a store D proposes the tuning of a vehicle 50 to a driver of the vehicle 50. The proposing system 100 is provided in order to determine the driving characteristics of the driver by information about the vehicle 50 collected by a vehicle-mounted device 1 and propose the tuning of the vehicle 50 appropriate for the driver.

Specifically, as shown in FIG. 1, the proposing system 100 is provided with the vehicle-mounted device 1 that collects information about the vehicle 50, a server apparatus 2 that stores the collected information about the vehicle 50, a personal computer (hereinafter, referred to as “PC”) 3, a display 4, and a driving simulator 5, the PC 3, the display 4, and the driving simulator 5 being provided in the store D. The vehicle-mounted device 1 and the server apparatus 2 are connected to each other via a network 150 and the server apparatus 2 and the PC 3 are connected to each other via the network 150.

### Vehicle-Mounted Device

The vehicle-mounted device 1 is detachably installed in the vehicle 50 that is driven by the driver. The vehicle-mounted device 1 is configured to acquire information about the vehicle 50 when the driver drives the vehicle 50 and transmit the information about the vehicle 50 to the server apparatus 2. That is, the vehicle-mounted device 1 is provided in order to store, in the server apparatus 2, a traveling record (traveling history) of the vehicle 50 driven by the driver. As shown in FIG. 2, the vehicle-mounted device 1 includes an acquisition terminal 11, a GPS (global positioning system) receiver 12, and a communicator 13. A vehicle-mounted network 51 of the vehicle 50 is connected to the acquisition terminal 11.

Here, the vehicle-mounted network 51 of the vehicle 50 includes a gateway ECU (hereinafter, referred to as “GW-ECU”) 52 and a plurality of buses 53 connected to the GW-ECU 52. A plurality of ECUs 54 is connected to each bus 53. The ECU 54 is configured to control each part of the vehicle 50. The buses 53 are transmission paths used when the ECUs 54 perform communication and as a communication protocol, a CAN (Controller Area Network) is used, for example. The GW-ECU 52 is provided to relay communication between the buses 53.

In addition, in a case where the ECU 54 transmits a message to the bus 53, the ECU 54 other than a transmission source that is connected to the bus 53 receives the message, the GW-ECU 52 transfers the message to another bus 53, and the ECU 54 connected to the other bus 53 receives the message. That is, in the case of the vehicle-mounted network 51, the ECUs 54 connected to the buses 53 different from each other can communicate with each other since messages are relayed by the GW-ECU 52. In addition, the ECUs 54 are configured to transmit traveling information (behavior information) of the vehicle 50 to the buses 53 in the form of a message. The traveling information of the vehicle 50 includes, an accelerator operation amount, a brake operation amount, a steering operation amount, a shifting operation, a vehicle speed, the degree of acceleration, a yaw rate, and the like.

The acquisition terminal 11 includes a microcomputer 11a that controls the acquisition terminal 11, a transceiver 11b connected to the microcomputer 11a, and an input and output unit 11c. The buses 53 of the vehicle-mounted network 51 are connected to the transceiver 11b and the GPS receiver 12 and the communicator 13 are connected to the input and output unit 11c. The microcomputer 11a is configured to acquire traveling information of the vehicle 50 via the transceiver 11b in a case where the traveling information of the vehicle 50 is transmitted from the ECUs 54 to the buses 53. Note that, the acquisition terminal 11 is an example of an “acquisition device” according to an aspect of the disclosure.

The GPS receiver 12 is configured to receive a signal from a GPS satellite (not shown) and calculate position information. In addition, the GPS receiver 12 also has a function of calculating the time of reception of a signal from the GPS satellite. In addition, the GPS receiver 12 is configured to output the position information and the time of the reception (hereinafter, also referred to as “GPS information”) to the acquisition terminal 11 at predetermined time intervals.

The communicator 13 can communicate with the server apparatus 2 via the network 150 and is provided in order to transmit, to the server apparatus 2, information about the vehicle 50 acquired by the acquisition terminal 11. The communicator 13 is provided exclusively for the vehicle-mounted device 1 and is connected to the acquisition terminal 11 by, for example, a wire.

In addition, the acquisition terminal 11 is configured to add additional information to traveling information and transmit the traveling information to the server apparatus 2 via the communicator 13 in a case where the traveling information is input from the vehicle-mounted network 51. The additional information includes a time at which the traveling information has been input to the acquisition terminal 11, identification information for specifying the acquisition terminal 11, and the like. In addition, the acquisition terminal 11 is configured to add additional information to GPS information and transmit the GPS information to the server apparatus 2 via the communicator 13 in a case where the GPS information is input from the GPS receiver 12. The additional information includes identification information for specifying the acquisition terminal 11 and the like. Note that, the traveling information with the additional information added thereto and the GPS information with the additional information added thereto constitute information about the vehicle 50.

### Server Apparatus

As shown in FIG. 1, the server apparatus 2 is configured to be able to communicate with the vehicle-mounted device 1 and the PC 3 via the network 150. Specifically, the server apparatus 2 is configured to store information about the vehicle 50 received from the vehicle-mounted device 1 as a traveling record and provide the traveling record to the PC 3. The server apparatus 2 includes a controller 21, a storage unit 22, and a communication unit 23.

The controller 21 is configured to control the server apparatus 2 by performing a calculation process. In the storage unit 22, a traveling record of the vehicle 50 or the like is stored. The traveling record of the vehicle 50 is composed of information about the vehicle 50 obtained when the vehicle 50 is driven by the driver. Therefore, the traveling record of the vehicle 50 includes a temporal change in GPS information from the GPS receiver 12 and a temporal change in traveling information from the vehicle-mounted network 51. The communication unit 23 is provided in order to communicate with the vehicle-mounted device 1 and the PC 3 via the network 150.

### Store

The store D is a store in which optional parts of the vehicle 50 are sold and a tuning service for the vehicle 50 is provided. The tuning of the vehicle 50 includes replacement of a component of the vehicle 50, adjustment of a component of the vehicle 50, addition (attachment) of a component to the vehicle 50, and removal of a component of the vehicle 50. Specific examples of the tuning of the vehicle 50 include attachment of an optional part to an engine, attachment of an optional part to a drive system, optimization of suspension, and replacement of a valve shim.

In the store D, the PC 3 for analyzing driving performed by the driver of the vehicle 50 is provided. The display 4 is connected to the PC 3 and the PC 3 is configured to be able to communicate with the server apparatus 2. The PC 3 is configured to reproduce a traveling record of the vehicle 50 stored in the server apparatus 2, on the display 4. That is, a visualizer for displaying position information and traveling information of the vehicle 50 provided from the server apparatus 2 on the display 4 is installed in the PC 3. For example, a visualizer screen is provided with a graph area, a map area, and the like. In the graph area, temporal changes about a vehicle speed, an accelerator, a brake, and a shifter are displayed and in the map area, a traveling path, a traveling trajectory, a vehicle position, and a vehicle advancing direction are displayed.

Therefore, a salesperson at the store D can analyze the driving (traveling record) of the vehicle 50 that is performed by the driver and displayed on the display 4 and determine the driving characteristics (driving tendency) of the driver. Then, the salesperson proposes the tuning of the vehicle 50 appropriate for the driver in accordance with the driving characteristics of the driver. The driving characteristics of the driver are determined based on, the way in which the accelerator is operated, the way in which the brake is operated, the way in which the steering wheel is operated, the way in which the shifter is operated, and the like. The tuning of the vehicle 50 to be proposed is decided based on the determined driving characteristics of the driver. That is, as the tuning of the vehicle 50 to be proposed, appropriate tuning is selected in accordance with the driving characteristics of the driver.

In addition, in the store D, a driving simulator 5 is provided. The driving simulator 5 is provided in order to cause the driver to have a simulated experience of driving the vehicle 50 before the tuning and cause the driver to have a simulated experience of driving the vehicle 50 after the tuning. That is, at the store D, the driver can have a simulated experience of how the vehicle 50 is changed through the tuning proposed by the salesperson by using the driving simulator 5 in advance.

### Proposing Method

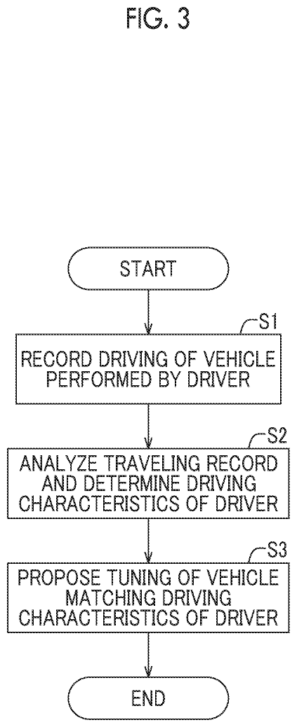

Next, a proposing method in which the proposing system 100 according to the embodiment is used will be described with reference to FIG. 3.

First, in step S1 in FIG. 3, driving of the vehicle 50 performed by a driver is recorded by the vehicle-mounted device 1. For example, in a case where the driver performs a circuit traveling or rally traveling by using the vehicle 50, driving at that time is recorded by the vehicle-mounted device 1.

Specifically, when the vehicle 50 is driven by the driver, acquisition terminal 11 adds additional information to traveling information and transmits the traveling information to the server apparatus 2 via the communicator 13 in a case where the traveling information is input to the acquisition terminal 11 from the vehicle-mounted network 51 and the acquisition terminal 11 adds additional information to GPS information and transmits the GPS information to the server apparatus 2 via the communicator 13 in a case where the GPS information is input to the acquisition terminal 11 from the GPS receiver 12. In the server apparatus 2, the traveling information and the GPS information are accumulated in the storage unit 22 in a case where the traveling information and the GPS information from the communicator 13 are received. That is, information about the vehicle 50 at the time of the driving of the vehicle 50 performed by the driver is accumulated in the server apparatus 2. The accumulated information about the vehicle 50 constitutes a traveling record of the vehicle 50.

Next, in step S2, the traveling record of the vehicle 50 is analyzed to determine the driving characteristics of the driver. Specifically, the PC 3 receives the traveling record of the vehicle 50 stored in the server apparatus 2 and the traveling record of the vehicle 50 is reproduced on the display 4 by the PC 3. For example, temporal changes about a vehicle speed, an accelerator, a brake, a shifter, a vehicle position, a vehicle advancing direction, and the like at the time of the driving of the vehicle 50 performed by the driver are displayed on the display 4. Then, a salesperson of the store D analyzes the driving (traveling record) of the vehicle 50 that is performed by the driver and displayed on the display 4 and determines the driving characteristics of the driver.

Next, in step S3, the tuning of the vehicle 50 matching the driving characteristics of the driver is proposed. Specifically, the tuning of the vehicle 50 appropriate for the driver is decided by the salesperson based on the driving characteristics of the driver and the salesperson proposes the tuning of the vehicle 50 to the driver. Then, the driver is caused to have a simulated experience of driving the vehicle 50 before and after the tuning by using the driving simulator 5. In addition, the salesperson may provide driving instruction to the driver.

### Effect

In the present embodiment, as described above, the traveling record of the vehicle 50 is analyzed to determine the driving characteristics of the driver and tuning of the vehicle 50 matching the driving characteristics of the driver is proposed. Therefore, it is possible to promote tuning matching the driving characteristics of each driver and thus it is possible to promote vehicle performance improvement appropriate for each driver. That is, the direction of vehicle performance improvement can be made appropriate for each driver. Accordingly, it is possible to propose the tuning of the vehicle 50 appropriate for a driver by using information about the vehicle 50 collected by the acquisition terminal 11 and thus it is possible to effectively use the information about the vehicle 50 collected by the acquisition terminal 11.

In addition, in the present embodiment, since the driving simulator 5 is provided, the driver can have a simulated experience of how the vehicle 50 is changed through proposed tuning. Therefore, it is possible to easily determine whether or not to apply the proposed tuning.

### Other Embodiment

Note that, the embodiment disclosed herein is illustrative in every respect, and offers no basis for restrictive interpretation. Therefore, the technical scope of the disclosure should not be interpreted by the above embodiment solely and is defined based on the description in the scope of the claims. In addition, the scope of the disclosure encompasses any modification within the meaning and scope equivalent to the scope of the claims.

For example, in the above-described embodiment, an example in which the proposing system 100 is provided with one vehicle 50 and one store D has been described. However, the disclosure is not limited thereto and the proposing system may be provided with a plurality of vehicles and a plurality of stores.

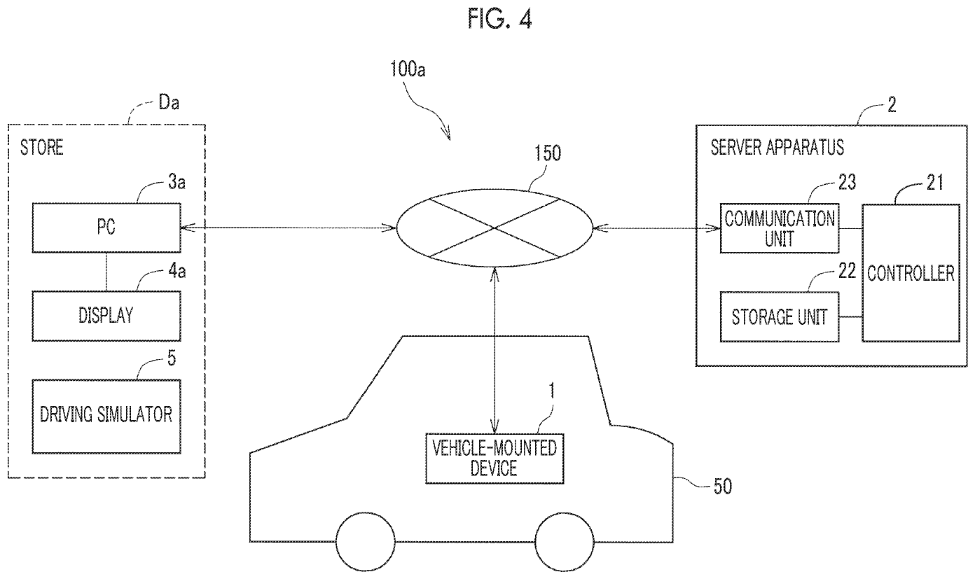

In addition, in the above-described embodiment, an example in which the salesperson of the store D analyzes the traveling record of the vehicle 50, determines the driving characteristics of the driver, and proposes the tuning of the vehicle 50 matching the driving characteristics of the driver has been described. However, the disclosure is not limited thereto and a PC 3a of a store Da may analyze the traveling record of the vehicle 50, determine the driving characteristics of the driver, and propose the tuning of the vehicle 50 matching the driving characteristics of the driver as in the case of a proposing system 100a according to a modification example shown in FIG. 4. A display 4a connected to the PC 3a is configured to able to display the contents of the tuning of the vehicle 50 proposed by the PC 3a. In this case, the PC 3a is an example of an “information processing apparatus” according to an aspect of the disclosure. In addition, the server apparatus may analyze a traveling record of a vehicle and determine the driving characteristics of a driver and a PC of a store may be notified of the tuning of the vehicle matching the driving characteristics of the driver as in the case of a proposing system according to another modification example (which is not shown). In this case, the server apparatus is an example of an “information processing apparatus” according to an aspect of the disclosure.

In addition, in the above-described embodiment, an example in which the driving simulator 5 is provided in the store D has been described. However, the disclosure is not limited thereto and no driving simulator may be provided in a store.

In addition, in the above-described embodiment, an example in which it is possible to have a simulated experience of driving the vehicle 50 before the tuning by using the driving simulator 5 has been described. However, the disclosure is not limited thereto and it may not be possible to have a simulated experience of driving a vehicle before the tuning as long as it is possible to have a simulated experience of driving the vehicle after the tuning by using a driving simulator.

In addition, in the above-described embodiment, an example in which information about the vehicle 50 that is used for driving analysis of the driver is transmitted to and stored in the server apparatus 2 has been described. However, the disclosure is not limited thereto and information about a vehicle that is used for driving analysis of a driver may be transmitted to and stored in a PC of a store.

In addition, in the above-described embodiment, an example in which the dedicated communicator 13 is connected to the acquisition terminal 11 with a wire and the communicator 13 communicates with the server apparatus 2 has been described. However, the disclosure is not limited thereto and a mobile communication terminal (for example, smartphone) carried by a driver may be connected to an acquisition terminal wirelessly and the mobile communication terminal may communicate with the server apparatus.

In addition, in the above-described embodiment, an example in which a CAN is used as a communication protocol of the vehicle-mounted network 51 has been described. However, the disclosure is not limited thereto and a communication protocol other than a CAN may be used as a communication protocol of a vehicle-mounted network.

In addition, in the above-described embodiment, an example in which position information of the vehicle 50 based on the GPS is acquired has been described. However, the disclosure is not limited thereto and position information of a vehicle based on a satellite position measurement system other than the GPS may be acquired.

In addition, in the above-described embodiment, an example in which the GPS receiver 12 outputs GPS information to the acquisition terminal 11 at predetermined time intervals has been described. However, the disclosure is not limited thereto and an acquisition terminal may request GPS information from a GPS receiver at predetermined time intervals and the GPS receiver may output the GPS information to the acquisition terminal in a case where the GPS receiver receives a request for the GPS information.

An aspect of the disclosure can be used for a proposing method of proposing the tuning of a vehicle and a proposing system.

What is claimed is:

1. A proposing method of proposing tuning of a vehicle, the method comprising:
a step of acquiring information about the vehicle by using an acquisition device installed in the vehicle when the vehicle is driven by a driver; and
a step of determining driving characteristics of the driver based on the information about the vehicle and proposing the tuning of the vehicle appropriate for the driver.

2. The proposing method according to claim 1, further comprising a step of causing the driver to have a simulated experience of driving the vehicle after the tuning by using a driving simulator.

3. A proposing system for proposing tuning of a vehicle, the system comprising:
an acquisition device configured to acquire information about the vehicle when the vehicle is driven by a driver, the acquisition device being installable in the vehicle; and
an information processing apparatus for determining driving characteristics of the driver based on the information about the vehicle and proposing the tuning of the vehicle appropriate for the driver.

4. The proposing system according to claim 3, further comprising a driving simulator for causing the driver to have a simulated experience of driving the vehicle after the tuning.
